(19) United States
(12) Patent Application Publication
(10) Pub. No.: US 2009/0031742 A1
(43) Pub. Date: Feb. 5, 2009

(54) Seat air conditioner for vehicle

(76) Inventors: Jeonghun Seo, Daejeon-si (KR); Gyuik Han, Daejeon-si (KR)

Correspondence Address: FULBRIGHT & JAWORSKI, LLP, 666 FIFTH AVE, NEW YORK, NY, 10103-3198, US

(21) Appl. No.: 11/887,865

(22) PCT Filed: Apr. 7, 2006
(86) PCT No.: PCT/KR2006/001281

§ 371 Date: Oct. 4, 2007

(30) Foreign Application Priority Data
Apr. 9, 2005 (KR) 10-2005-0029705
Mar. 24, 2006 (KR) 10-2006-0026857

(51) Int. Cl. B60H 1/32; A47C 7/72

(52) U.S. Cl. 62/244; 297/180.14

(57) ABSTRACT

The present invention relates to a seat air conditioner for a vehicle, which induces air passing through a blower unit of a front air conditioner thereinto and has a thermoelectric module mounted on a seat without mounting additional air blast on the seat, thereby reducing noise, manufacturing costs and a limitation in space of the seat due to a simplified configuration, independently controlling a seat air-conditioning, and conducting a combined control with an indoor air inducing mode of the blower unit in order to improve cooling and heating efficiencies.

### TECHNICAL FIELD

The present invention relates to a seat air conditioner for a vehicle, and more particularly, to a seat air conditioner for a vehicle, which induces air passing through a blower unit of a front air conditioner thereinto and has a thermoelectric module mounted on a seat without mounting additional air blast on the seat, thereby reducing noise, manufacturing costs and a limitation in space of the seat due to a simplified configuration, independently controlling a seat air-conditioning, and conducting a combined control with an indoor air inducing mode of the blower unit in order to improve cooling and heating efficiencies.

### BACKGROUND ART

In general, an air conditioner for a vehicle is a car trim, which is installed in the vehicle in order to secure a driver's front and rear visual field by heating and cooling the inside of the vehicle in the summer season or the winter season or removing frost from a windshield in case of rain or the winter season. Since such air conditioner includes a heating device and a cooling device together, the air conditioner heats, cools or ventilates the inside of the vehicle through the steps of selectively inducing the indoor air or the outdoor air through a blower unit, heating or cooling the air, and blowing into the vehicle.

Such air conditioner is classified into a three-piece type where a blower unit, an evaporator unit, and a heater core unit are disposed independently, a semi-center type where the evaporator unit and the heater core unit are embedded in an air-conditioning case and the blower unit is mounted separately, and a center-mounting type where the three units are all embedded in the air-conditioning case.

Furthermore, a two-layer air conditioner has been developed in order to secure a defogging efficiency during heating and maintain a heating efficiency of high quality. That is, the conventional air conditioner for the vehicle induces cooled outdoor air of low humidity since the cooled outdoor air is effective to remove frost from a window during traveling the vehicle while heating in the winter season, but it causes lowering of the room temperature. In the above case, the two-layer air conditioner realizes air flow of double laminar flows that the outdoor air is supplied to the upper part of the vehicle and the indoor air is circulated in the lower part of the vehicle, whereby the air conditioner can effectively remove frost using the fresh outdoor air of low humidity supplied to the upper part and maintain the heating efficiency of high quality by supplying the warm indoor air to the lower part.

The conventional air conditioners described above are generally front air conditioners for air-conditioning of the front seat, and some of them are rear air conditioner for air-conditioning of the rear seat.

Moreover, there have been disclosed seat air conditioners for vehicles, which can make a passenger's back and hips agreeable by heating and cooling a seat of the vehicle by bypassing heat-exchanged air from the front air conditioner to the front seat in link with the front air conditioner. FIG. 1 shows an example of such seat air conditioner for vehicle (Japanese Patent Publication No 1999-263116 (Sep. 28, 1999).

The seat air conditioner for the vehicle shown in FIG. 1 includes a connection duct 30 extending from an air-conditioning case 21 constituting a front air conditioner 20 to a car seat 10, and a blower 40 mounted on the connection duct 30. That is, the car seat 30 has an air passage 12 for discharging air toward a passenger, and the air passage 12 is connected with the connection duct 30, whereby air is effectively blown from an outlet of the air-conditioning case 21 to the air passage 12 through the connection duct 30 by operation of the blower 40.

However, the conventional seat air conditioner for the vehicle that air discharged from the front air conditioner 20 is supplied to the seat 10 has several disadvantages in that its configuration is complicated since air heat-exchanged in the front air conditioner 20 is controlled by doors and in that the seat air conditioner causes excessively thermal loss while air passes through the connection duct 30.

Additionally, the conventional seat air conditioner, which receives air discharged from the front air conditioner 20, has another disadvantage in that it is difficult to independently air-condition only the seat 10 since the heat-exchanged air is always blown toward the car seat 10 from the air-conditioning case 21 when the front air conditioner 20 is operated.

Furthermore, the conventional seat air conditioner has a further disadvantage in that it causes limitation in space, noise, a complicated configuration, and expensive manufacturing costs since the blower 40 for the car seat 10 must be separately mounted without regard to the blower unit (not shown) of the front air conditioner 20.

Meanwhile, a seat air conditioner for a vehicle, which is independent from the front air conditioner 20, has been proposed. For an example, there is Korean Patent No. 372,088. The seat air conditioner for the vehicle includes two temperature-adjustable heat pump for blowing air to a seat back and a seat cushion, and each temperature-adjustable heat pump includes at least one thermoelectric device for adjusting temperature of the air according to selection of heating and cooling.

Such seat air conditioner for the vehicle can independently air-condition the car seat, but has a disadvantage in that it causes expensive manufacturing costs, noise and deteriorated efficiency since the heat pumps are mounted separately from the front air conditioner.

### DISCLOSURE OF INVENTION

### Technical Problem

Accordingly, the present invention has been made to solve the above-mentioned problems occurring in the prior art, and it is an object of the present invention to provide a seat air conditioner for a vehicle, which induces air passing through a blower unit of a front air conditioner thereinto and has a thermoelectric module mounted on a seat without mounting additional air blast on the seat, thereby reducing noise, manufacturing costs and a limitation in space of the seat due to a simplified configuration, independently controlling a seat air-conditioning, and conducting a combined control with an indoor air inducing mode of the blower unit in order to improve cooling and heating efficiencies.

### Technical Solution

To accomplish the above object, according to the present invention, there is provided a seat air conditioner for a vehicle including: a connection duct for communicating an outlet of a blower unit of a front air conditioner with a seat for supplying air passing through the blower unit to the seat before the air passes a heat exchanger; a door mounted at an inlet of the connection duct for controlling air volume discharged from the blower unit and distributing the air into the front air conditioner and the connection duct; and a thermoelectric module mounted in the connection duct for thermally exchanging with the air flowing through the connection duct.

### BRIEF DESCRIPTION OF THE DRAWINGS

Further objects and advantages of the invention can be more fully understood from the following detailed description taken in conjunction with the accompanying drawings, in which:

FIG. 1 is a structural view of a conventional seat air conditioner for a vehicle;

FIG. 2 is a brief structural view showing a state where a seat air conditioner for a vehicle according to the present invention is connected to a general front air conditioner;

FIG. 3 is a perspective view showing the state where the seat air conditioner for the vehicle according to the present invention is connected to the general front air conditioner;

FIG. 4 is a brief structural view showing a state where the seat air conditioner for the vehicle according to the present invention is connected to a two-layer air conditioner; and

FIG. 5 is a brief structural view showing a state where a seat air conditioner for a vehicle according to another embodiment of the present invention is connected to the general front air conditioner.

### BEST MODE FOR CARRYING OUT THE INVENTION

Reference will be now made in detail to the preferred embodiment of the present invention with reference to the attached drawings.

In the present invention, description of the same configuration and action as the prior arts will be omitted.

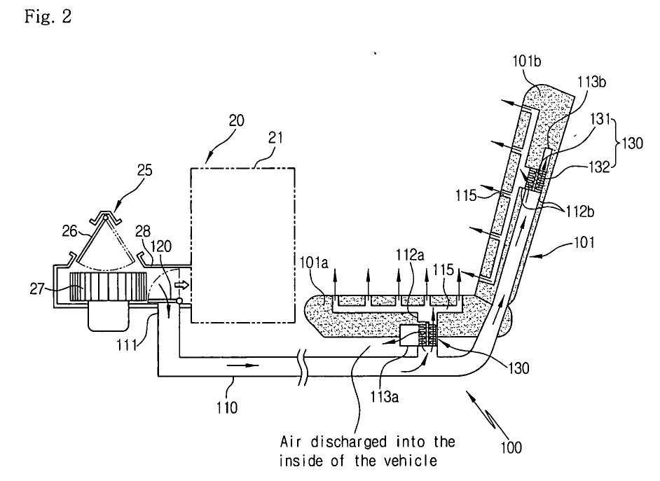

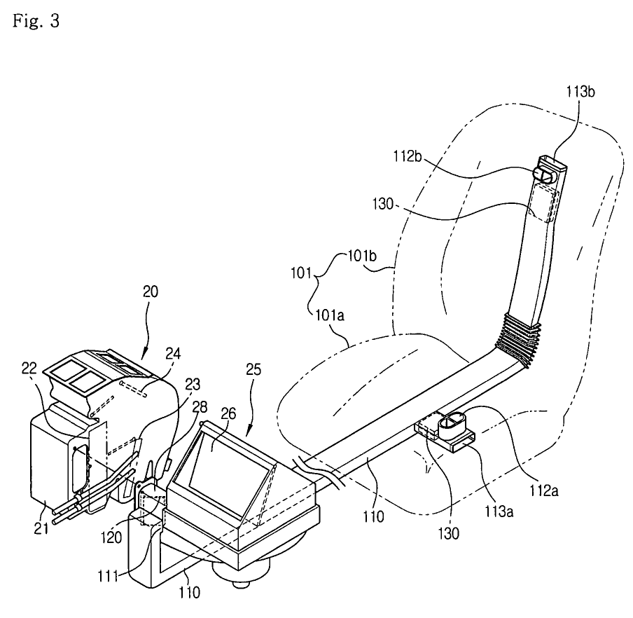

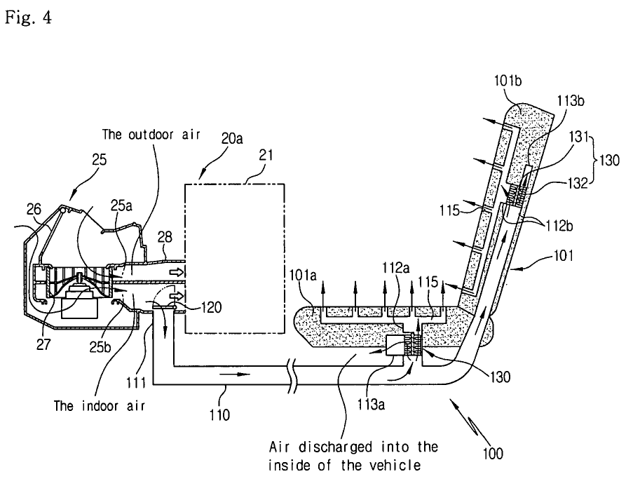

FIG. 2 is a brief structural view showing a state where a seat air conditioner for a vehicle according to the present invention is connected to a general front air conditioner, FIG. 3 is a perspective view showing the state where the seat air conditioner for the vehicle according to the present invention is connected to the general front air conditioner, and FIG. 4 is a brief structural view showing a state where the seat air conditioner for the vehicle according to the present invention is connected to a two-layer air conditioner.

First, a front air conditioner 20, to which a connection duct 110 of a seat air conditioner 100 for a vehicle according to the present invention is connected, will be described in brief. The front air conditioner 20 includes a heat exchanger (an evaporator 22 and a heater core 23) mounted on the internal passageway thereof for thermally exchange air, an air-conditioning case 21 having a number of doors 24 for controlling a flow direction of air, and a blower unit 25 mounted at a side of the air-conditioning case 21 for blowing the indoor air and the outdoor air into the air-conditioning case 21.

The blower unit 25 includes an intake door 26 mounted therein and operated by controlling means, such as an actuator (not shown), for selectively inducing the indoor air or the outdoor air according to an indoor air inducing mode or an outdoor air inducing mode, and a blast fan 27 for forcedly blowing the indoor air or the outdoor air selectively induced by the intake door 26 toward the air-conditioning case 21.

Meanwhile, as shown in FIG. 4, in the case where the front air conditioner 20 is a two-layer air conditioner 20a for inducing the indoor air and the outdoor air after separating them into the upper part and the lower part, the blower unit 25 is divided into the upper part of an outdoor air passageway 25a for flowing the outdoor air therein and a lower part of an indoor air passageway 25b for flowing the indoor air therein.

Description of such front air conditioner 20 and two-layer air conditioner 20a will be omitted since they have been disclosed.

The seat air conditioner 100 for the vehicle according to the present invention includes the connection duct 110, a door, and a thermoelectric module 130.

The connection duct 110 is mounted in such a way as to communicate an outlet 28 of the blower unit 25 with a seat 101 for supplying air passing through the blower unit 25 of the front air conditioner 20 to the seat 101 before the air passes through the heat exchanger 22 and 23.

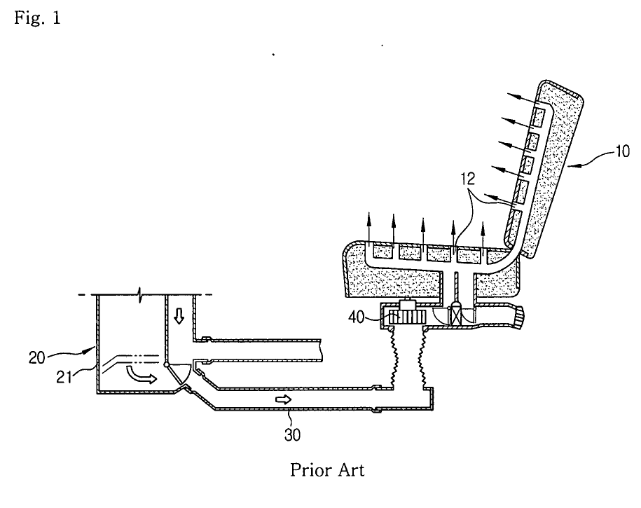

That is, the conventional air conditioner provides the seat 10 with the air finally discharged after passing the heat exchanger and the doors from the front air conditioner 20 using the separate blower 40 (see FIG. 1) mounted on the seat 10 (see FIG. 1). However, the present invention provides the seat 101 with air by bypassing air toward the seat 101 through the connection duct 110 directly after the air passes through the blower unit 25 of the front air conditioner 20. Therefore, the present invention can air-condition the seat 101 only by the blower unit 25 of the front air conditioner 20 without needing additional air blast on the seat 101.

Here, an inlet 111 of the connection duct 110 is branched from a side of the outlet 28 of the blower unit 25, whereby a part of the air blowing toward the air-conditioning case 21 from the blower unit 25 is bypassed to the connection duct 110 and supplied to the seat 101.

Meanwhile, a height of the connection duct 110 and a size of the inlet 111 of the connection duct 110 can be properly decided according to an induced air volume.

It is preferable that the indoor air is induced into the air conditioner 100 during air-conditioning of the seat 101 for heating and cooling efficiencies. That is, when the seat air conditioner 100 air-conditions the seat 101 by inducing the indoor air of the vehicle, the seat air conditioner 100 can improve heating and cooling efficiencies since heating load or cooling load is reduced more than the case where the outdoor air is induced into the air conditioner 100.

To induce the indoor air into the seat air conditioner 100 during air-conditioning of the seat 101, there are two methods as follows.

First, the indoor air induced through the blower unit 25 is supplied to the seat 101 through the connection duct 110 by converting the blower unit 25 into the indoor air inducing mode. That is, when the air conditioner air-conditions the seat 101, the actuator (not shown) for operating the intake door 26 of the blower unit 25 is controlled, whereby the mode of blower unit 25 is switched into the indoor air inducing mode.

Second, in the case where the front air conditioner 20 is the two-layer air conditioner 20a for inducing the indoor air and the outdoor air by dividing them into the upper part and the lower part, the inlet 111 of the connection duct 110 is communicated with the indoor air passageway 25b of the blower unit 25.

That is, in the case where the seat air conditioner 100 of the present invention is applied to the two-layer air conditioner 20a, since the outdoor air flows in the upper part of the blower unit 25 and the indoor air flows in the lower part of the blower unit 25, the inlet 111 of the connection duct 110 is connected to the lower portion of the outlet 28 of the blower unit 25 so as to be communicated with the indoor air passageway 25b, so that the seat air conditioner 100 can improve heating and cooling efficiencies by supplying the indoor air to the seat 101 through the connection duct 110 during the indoor air inducing mode or a two-layer mode.

Meanwhile, outlets 112a and 112b of the connection duct 110 are branched in such a way as to be respectively connected with a cushion part 101a and a seat back part 101b of the seat 101. Moreover, the cushion part 101a and the seat back part 101b of the seat 101 respectively have a number of branched blast passageways 115 for uniformly blowing the air blown through the connection duct 110 toward a passenger's hips and back.

The blast passageways 115 of the cushion part 101a and the seat back part 10b of the seat 101 are respectively connected with outlets 112a and 112b of the connection duct 110, which are respectively branched into several parts and united into one at the cushion part 101a and the seat back part 101b. At this time, as described above, the outlets 112a and 112b of the connection duct 110 can be respectively branched into several parts and united into one at the cushion part 101a and the seat back part 101b, but in the case where the blast passageway 115 of the cushion part 101a and the blast passageway 115 of the seat back part 101b are communicated with each other, the outlets 112a and 112b of the connection duct 110 are not branched, and connected to one of the cushion part 101a and the seat back part 101b.

The thermoelectric module 130 is mounted on the connection duct 110 for heat-exchanging the air flowing toward the seat 101 through the connection duct 110.

Here, it is preferable that the thermoelectric modules 130 are respectively mounted in the outlets 112a and 112b branched from the connection duct 110, but the thermoelectric modules 130 may be selectively mounted at any proper places of the connection duct 110 according to a purpose.

The thermoelectric module 130 includes a thermoelectric element 131 for absorbing heat at one side thereof and generating heat at the other side according to a flow direction of electric current, and heat-transmitting means 132 mounted at both sides of the thermoelectric element 131. The heat-transmitting means 132 may be heat-exchange blocks or heat-exchange radiation fins made of aluminum.

Therefore, the thermoelectric module 130 can heat and cool air flowing from the blower unit 25 toward the seat 101 through the connection duct 110 since it can simultaneously absorb and generate heat through converting poles (+,−) of electric current.

As described above, when air passing through the connection duct 110 passes through the thermoelectric module 130, the air passing through one side of the thermoelectric element 131 is cooled, but the air passing through the other side of the thermoelectric element 131 is heated. Due to the above feature, discharge passageways 113a and 113b are formed at the outlets 112a and 112b branched from the connection duct 110 so as to discharge unnecessary air of the air of different temperatures (cooled air and heated air), which is heat-exchanged by the thermoelectric module 130, into the vehicle.

That is, necessary air of the cooled and heated air heat-exchanged through the thermoelectric module 130 is discharged to the seat 101 through the outlets 112a and 112b of the connection duct 110, and the unnecessary air is discharged into the vehicle through the discharge passageways 113a and 113b.

Here, it is preferable that the air discharged through the discharge passageway 113b of the seat back part 101b is discharged into the seat back part 101b so as not to directly have any influence on the passenger who seats on the rear seat. At this time, the air discharged into the seat back part 101b is discharged into the vehicle through a side of the seat back part 101b.

Moreover, a door 120 is mounted at the inlet 111 of the connection duct 110 for controlling air volume discharged from the blower unit 25 and distributing the air volume into the front air conditioner 20 and the connection duct 110. The door 120 is controlled by the actuator (not shown) and adjusts the air volume flowing into the connection duct 110 during air-conditioning of the seat 101.

That is, the seat air-conditioning is in OFF-mode when the door 120 closes the inlet 111 of the connection duct 110, and the seat air-conditioning is in ON-mode but the front air-conditioning is in OFF-mode when the door 120 completely opens the inlet 111 of the connection duct 110 and closes the outlet 28 of the blower unit 25. Additionally, when the door 120 simultaneously opens the inlet 111 of the connection duct 110 and the outlet 28 of the blower unit 25, the seat air-conditioning and the front air-conditioning are simultaneously conducted.

As described above, the present invention can independently control the seat air-conditioning without regard to operation of the front air conditioner 20 by directly supplying the air passing through the blower unit 25 to the seat 101 using the connection duct 110 and mounting the door 120 at the inlet 111 of the connection duct 110.

Hereinafter, the operation of the seat air conditioner 100 for the vehicle according to the present invention will be described.

To cool the seat 101, the door 120 opens the inlet 111 of the connection duct 110, and then, the outlet 28 of the blower unit 25 of the front air conditioner 20 and the seat 101 are communicated with each other. At this time, the air volume blowing toward the seat 101 through the connection duct 110 is controlled according to an opening angle of the door 120.

Furthermore, the thermoelectric module 130 conducts a cooling action. That is, the thermoelectric module 130 cools the air flowing toward the seat 101 from the thermoelectric element 131 by heat absorption and heats the air discharged into the vehicle through the discharge passageways 113a and 113b by heat radiation.

Therefore, the seat 101 is cooled through a process that the air blowing from the blower unit 25 of the front air conditioner 20 is cooled by the thermoelectric module 130 during flowing toward the seat 101 through the connection duct 110 and then discharged toward the passenger's hips and back through the blast passages 115 formed at the outlets 112a and 112b of the connection duct 110.

Next, to heat the seat 101, the door 120 opens the inlet 111 of the connection duct 110, and then, the outlet 28 of the blower unit 25 of the front air conditioner 20 and the seat 101 are communicated with each other. At this time, the air volume blowing toward the seat 101 through the connection duct 110 is controlled according to an opening angle of the door 120.

Furthermore, the thermoelectric module 130 conducts a heating action. That is, the thermoelectric module 130 heats the air flowing toward the seat 101 from the thermoelectric element 131 by heat radiation and cools the air discharged into the vehicle through the discharge passageways 113a and 113b by heat absorption.

Therefore, the seat 101 is heated through a process that the air blowing from the blower unit 25 of the front air conditioner 20 is heated by the thermoelectric module 130 during flowing toward the seat 101 through the connection duct 110 and then discharged toward the passenger's hips and back through the blast passages 115 formed at the outlets 112a and 112b of the connection duct 110.

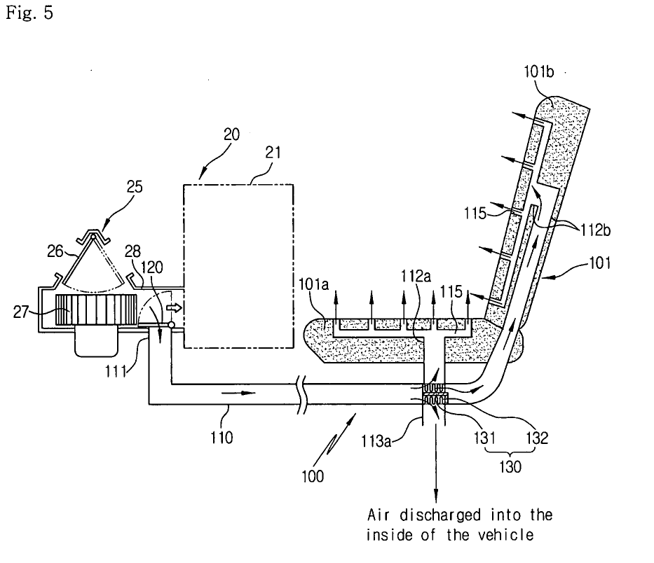

FIG. 5 is a brief structural view showing a state where a seat air conditioner for a vehicle according to another embodiment of the present invention is connected to the general front air conditioner. In the above embodiment, the thermoelectric modules 130 are respectively mounted at the outlets 112a and 112b which are respectively branched from the connection duct 110 and connected to the cushion part 101a and the seat back part 101b of the seat 101. However, in FIG. 5, just one thermoelectric module 130 capable of simultaneously heating and cooling the cushion part 101a and the seat back part 101b is mounted.

That is, the outlets 112a and 112b are branched from the connection duct 110 so as to be respectively connected to the cushion part 101a and the seat back part 101b, and the thermoelectric module 130 is mounted at the branched position. At this time, the heat-transmitting means 132 of one side of the thermoelectric element 131 is communicated with the outlets 112a and 112b of the connection duct 110, and the heat-transmitting means 132 of the other side of the thermoelectric element 131 is communicated with the discharge passageway 113a.

Therefore, the seat 101 is cooled or heated through a process that the air blowing from the blower unit 25 of the front air conditioner 20 and induced into the connection duct 110 is cooled or heated by the thermoelectric module 130 during flowing through the connection duct 110, branched toward the outlets 112a and 112b of the connection duct 110, and then, discharged toward the passenger's hips and back through the blast passageways 115.

At this time, necessary air of the air cooled or heated by the thermoelectric module 130 flows toward the outlets 101a and 101b branched from the connection duct 110 and is discharged toward the passenger, but unnecessary air is discharged into the vehicle through the discharge passageway 113a.

### INDUSTRIAL APPLICABILITY

According to the present invention, since the seat air conditioner for the vehicle induces the air passing through the blower unit of the front air conditioner and uses the thermoelectric modules for heating and cooling of the seat without using additional air blast mounted on the seat, the present invention can prevent noise generated by operation of the air blast, reduce manufacturing costs, simplify its configuration, and reduce limitation in space of the seat.

Furthermore, since the inlet of the connection duct is connected with the outlet of the blower unit and the door is mounted at the inlet of the connection duct, the present invention can independently control the seat air-conditioning without regard to the operation of the front air conditioner.

Moreover, the present invention can improve the cooling and heating efficiencies by inducing the indoor air of the vehicle into the seat air conditioner during the seat air-conditioning through a combined control with the indoor air inducing mode of the blower unit.

1. A seat air conditioner for a vehicle comprising:
a connection duct for communicating an outlet of a blower unit of a front air conditioner with a seat for supplying air passing through the blower unit to the seat before the air passes through a heat exchanger;
a door mounted at an inlet of the connection duct for controlling air volume discharged from the blower unit and distributing the air into the front air conditioner and the connection duct; and
a thermoelectric module mounted in the connection duct for thermally exchanging with the air flowing through the connection duct.

2. A seat air conditioner for a vehicle according to claim 1, wherein the blower unit is controlled in such a way that a mode of the blower unit is switched into an indoor air inducing mode so as to improve cooling and heating efficiencies by inducing the indoor air into the seat air conditioner through the blower unit during a seat air-conditioning.

3. A seat air conditioner for a vehicle according to claim 1, wherein, in the case where the front air conditioner is a two-layer air conditioner for dividing the indoor air and the outdoor air into the upper part and the lower part and inducing them into the front air conditioner, the inlet of the connection duct is communicated with an indoor air passageway of the air passageways of the blower unit so as to improve the cooling and heating efficiencies.

4. A seat air conditioner for a vehicle according to claim 1, wherein outlets of the connection duct are respectively branched from the connection duct 110 and communicated with a cushion part and a seat back part of the seat, and the thermoelectric modules are respectively mounted at the outlets of the connection duct.

5. A seat air conditioner for a vehicle according to claim 4, wherein the outlets branched from the connection duct respectively have discharge passageways for discharging unnecessary air out of the air of different temperatures, which is thermally exchanged through the thermoelectric module, into the vehicle.
